(19) United States
(12) Patent Application Publication
(10) Pub. No.: US 2016/0086375 A1
(43) Pub. Date: Mar. 24, 2016

(54) System and Method for Three Dimensional Reconstruction, Measurement and Visualization

(71) Applicant: RAVIKIRAN DEVAKI, BANGALORE (IN)

(72) Inventor: RAVIKIRAN DEVAKI, BANGALORE (IN)

(21) Appl. No.: 14/555,810

(22) Filed: Nov. 28, 2014

(30) Foreign Application Priority Data
Sep. 22, 2014 (IN) 4606/CHE/2014

(51) Int. Cl. G06T 17/20; G06T 19/00; G06T 3/00; G06F 17/50

(52) U.S. Cl. CPC G06T 17/20; G06F 17/50; G06T 19/006; G06T 3/0056

(57) ABSTRACT

A system, method, and computer program products for window and door design are described. More particularly, a computer implemented system and method is described for three dimensional reconstruction and transformation, measurement and three dimensional visualization of any objects. In one aspect, a computer implemented system and method is described for three dimensional reconstruction and transformation for automatic measurement and three dimensional visualization, so as to be able to measure dimensions of products from a photograph and visualize same.

### CROSS-REFERENCE TO RELATED APPLICATION

The instant application claims priority to Indian Patent Application Ser. No. 4606/CHE/2014, filed Sep. 22, 2014, the entire specification of which is expressly incorporated herein by reference.

### FIELD OF THE INVENTION

The present invention relates generally to a system, method, and computer program products, and more particularly to a computer implemented system and method for three dimensional (3D) reconstruction and transformation for automatic measurement and 3D visualization of any objects using a photograph/image.

### BACKGROUND OF THE INVENTION

Designing the layout and products to include in a room such as windows and door frames can be a time consuming process. For example, a person designing a room window and door can select various products to include in the room by collecting pages from magazines or from the Internet. The person designing the windows and doors can later view these pages when selecting a product to purchase. The person designing the windows and door may also use a computer-aided design (CAD) program or tool to generate a computer based layout of the window and door that includes the placement of various items within the room. If the person designing the windows and door has questions about the items to include in the room or the layout of the windows and doors, he/she may ask a salesperson at a store about products or ask friends for recommendations or opinions about various aspects of his/her design.

Typically owner spends enormous amount of time planning an improvement project pertaining to designing windows and doors. The result can be an unorganized collection of pages torn out of magazines and catalogs, stacks of books with bookmarked pages, lengthy Internet Explorer “Favorites” lists with poor naming conventions and sketches of designs that are not to scale.

Further, there exist challenges in getting accurate measurements for windows and doors that can be passed on to the factory for further processing. While manual tape-measurements are error prone and have limitations based on the size of the object, at present there exists no commercial tool in order to automatically get accurate measurements with respect to width and height of an object. There is typically a lot of rework in manufacturing, back-and-forth travel to get the accurate measurements.

Thus, there exists a need for sales people of these manufacturers a tool that provides accurate measurement, which is key to pass it to manufacturing unit to manufacture the product. Further, there exists a need to eliminate manual tape based as well as digital measurement tools.

In addition to the measurement, it is also difficult for consumer to visualize the 3D view of the windows or doors (and other products that depend on aesthetics) during the quote/order process unless it is implemented physically. Consumer satisfaction is improved when customers can have efficient visualization tools for purchase decisions.

### SUMMARY OF THE INVENTION

The main object of the present invention is to provide a computer implemented system and method for 3D reconstruction and transformation for automatic measurement and 3D visualization of any objects using a photograph/image.

Yet another object of the present invention is to provide a tool, which provides accurate measurement, in order to enable manufacturing unit to manufacture the product.

It is yet another object to provide a tool to eliminate manual tape based as well as digital measurement tools in order to avoid errors and various limitations associated with size, design and development of the products.

Another object is to provide a tool to visualize the model in 3D, in the environs of the consumer.

In accordance with an illustrative embodiment of the present invention, a computer implemented system for 3D reconstruction and transformation for automatic measurement and 3D visualization of any objects using a photograph/image, comprising:

a processor unit;

a computer readable medium storing instructions executable by the processor unit to perform the steps of:

capturing an image on a device;

viewing a photograph of the image on the device; and

performing a transforming operation on the image using at least one reconstruction or interpolation algorithm.

The details of one or more implementations of the invention are set forth in the accompanying drawings and the description below. Other features and advantages of the invention will become apparent from the description, the drawings, and the claims.

### BRIEF DESCRIPTION OF THE DRAWINGS

FIG. 1 is a screen shot of one of the embodiments of the present invention showing the working screen for window and door configurations having measurement and design options using the present invention.

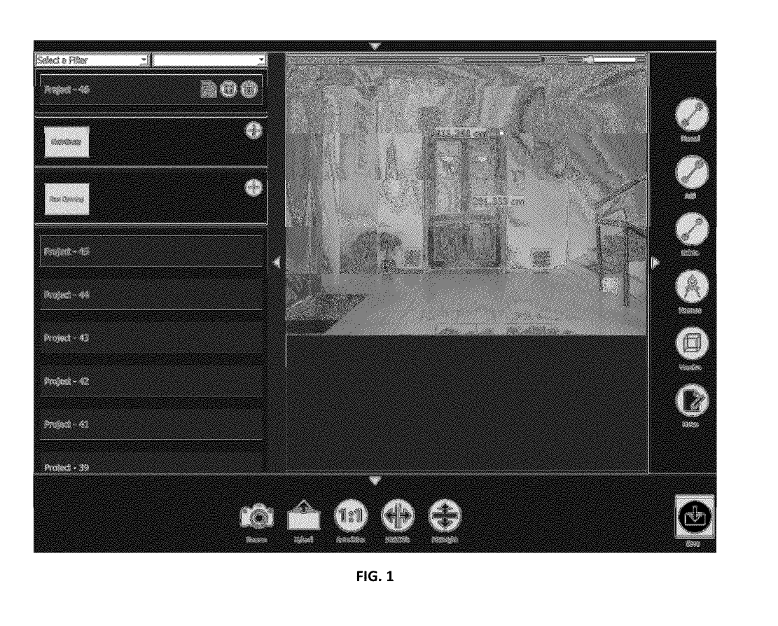

FIG. 2 is a screen shot of yet another embodiment of the present invention showing the working screen for window and door configurations having design and aesthetic options using the present invention.

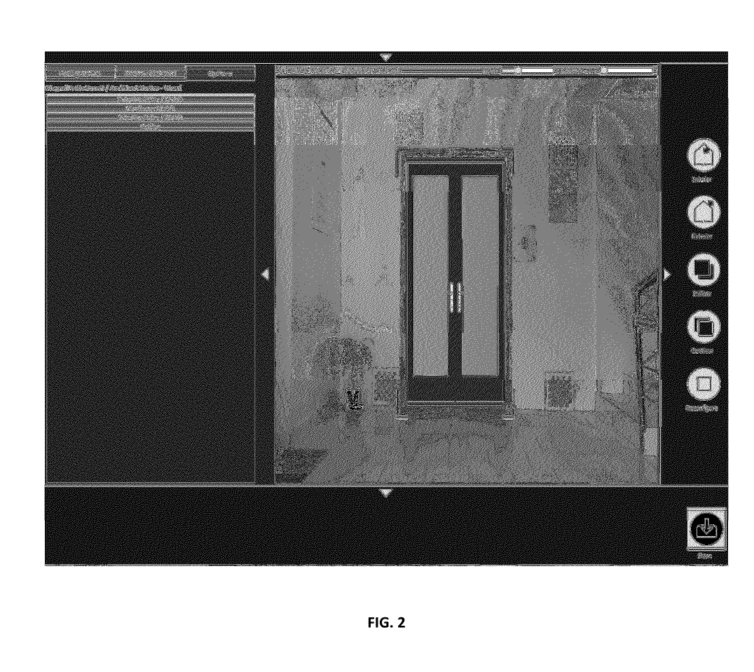

FIG. 3 is an outline of a system architecture depicting the primary elements of the embodiments of the present invention.

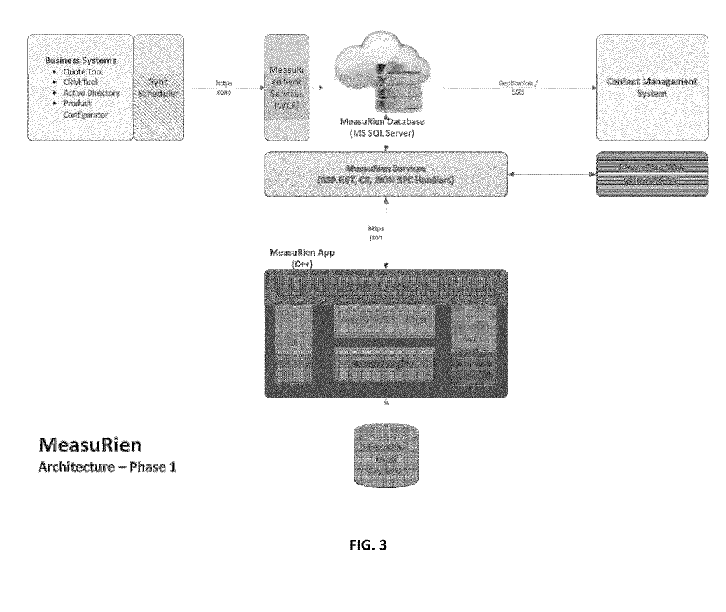

FIG. 4 is a process flow chart depicting an exemplary execution of the present invention using the method and system of measurement and visualization of windows and doors.

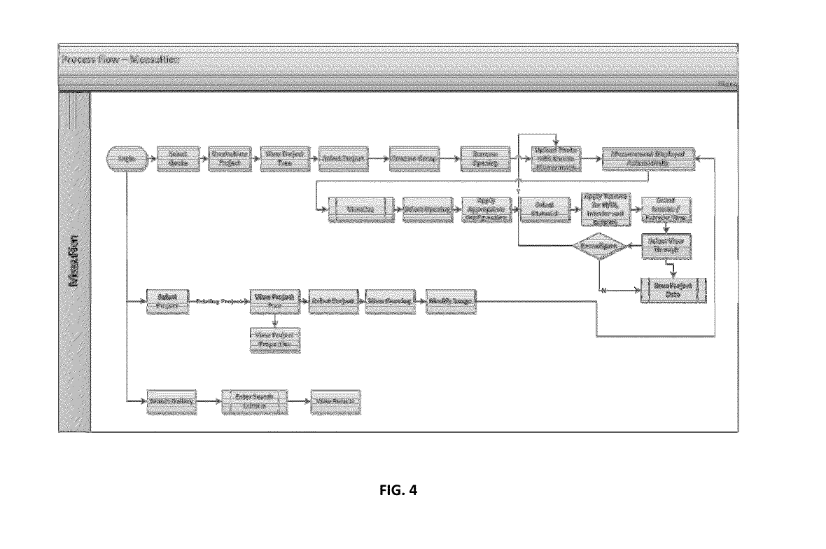

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well-known structures and devices are shown in block diagram form order to avoid obscuring the concepts of the present invention.

Referring to the Figures, the present invention provides a system, method, and computer program product for windows and doors, and more preferably to a computer implemented system and method for 3D reconstruction and transformation for automatic measurement and 3D visualization and able to measure dimensions of products from a photograph.

An embodiment of the present invention provides photogrammetric real-world measurement and customer visualization capabilities. Product visualization using computer graphics are also one of the applications features, wherein said system calculates dimensions in specific existing opening by analyzing dimensions from identified feature points and known feature points included in the photograph of the window or door needing replacement. The system of the present invention eliminates waste produced from errors in measuring as well as production of non-fitting custom products. It also allows the customer to visualize/pre-view their space with the new product in a 3D rendering on the spot in their current environment.

The system enables the digital measurements to be superimposed over the captured images. In addition to automatically detected known feature points, the program automatically identifies additional image features. The digital measurements are displayed between user-selected feature points in the images making it user-friendly product visualization.

In accordance with one of the embodiment of the present invention, the visual capturing features in mobile devices allow 3D computing and reconstruction. An important embodiment of the present invention is the ability to capture an image on the device, view photographs on the device and perform processing operations on the images using reconstruction and interpolation algorithms.

The system detects known measured objects on the photograph and calculates their dimension to pixel ratio, by considering angle of the photo taken. It then interpolates and calibrates the ratio across the image to calculate the dimensions for user selected feature points. The images are reconstructed and transformed in 3D with respective angles that existed in the 2D image, this will also have all the objects that are to be measured cut and replaced.

The product allows for measurement to be done on pictures taken on the device. The product allows for 3D visualization of the chosen model installation in the openings in the room.

The prototype displays measurements as an electronic fluorescent display superimposed over the captured images. The measurements show distances between two selected feature points. The measurements are displayed as line distances between two feature points.

In yet another embodiment of the present invention, an algorithm accepts a list of feature-points from the photograph, and calculates the variance and interpolates across the photographs to the relative distance, and this distance is then scaled to find the real physical distance such as feet/meters and the like. Moreover, the visualization is achieved using perspective correction and 3D transformation of the photograph.

The computer readable program of the invention may run on a tablet device, a laptop, a desktop computer, and/or the like (including mobile devices). By way of a non-limiting example, a digital camera may be used to take high resolution photographs and the present invention allows for the photographs to be uploaded for addition of feature points, measurements, product visualization, linking to a quote and search for quotes and previous photographs from a photograph gallery.

In an embodiment of the present invention, there is provided a method using the system of the invention, comprising the steps wherein the user clicks on the MeasuRien icon and launches the application from the laptop or the tablet device. “MeasuRien” is the name of the product icon that appears on the desktop that the user will click and run the application. This also appears as “App” icons on the device. After the log in screen gets displayed, the user enters the license key for the application when logging in for the first time, and also enters his/her user credentials. Further, the welcome home page is then displayed. The user then selects a new project or updates an existing project.

The new project icon activates a window for a new project to be created and select the specific Quote ID (e.g., a Unique identifier for the quotation in the system) and the product line item for which the measurement calculations and 3D rendering of the selected model needs to be done. Once the user uploads the photograph of the openings along with the known measurement object embedded (interior or exterior view) to the system, the system detects the corner feature points, and provides the measurements automatically.

Further, the user may select the opening and browse through the various options of the windows/doors and select one model and click on the product that the customer likes to see how it will look in the existing opening. The system enables the user to preview all the options available and thereby select the textures and apply for the specific model selected. The user is able to zoom in on the model to view the hardware and also zoom out. Upon finalizing the model, the user may click on the save project icon, capturing the screenshot of the model selected for the opening and save all the data. Further, the project data is saved and mapped to the specific quote. Moreover, the user can search for previous products and photographs along with the measurements.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device. Examples of a computing device may include, but are not limited to, an electronic book reading device, a computer workstation, a terminal computer, a server computer, a handheld device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

The computer device may also include an input device. In one example, a user of the computer device may enter commands and/or other information into computer device via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device via a storage device (e.g., a removable disk drive, a flash drive, etc.) and/or a network interface device. A network interface device, such as network interface device may be utilized for connecting the computer device to one or more of a variety of networks, such as a network, and one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device via a network interface device.

The computer device may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present in is not intended to be limited to the embodiments shown herein but is to be accorded the widest scope consistent with the principles and novel features disclosed herein.

What is claimed is:

1. A computer implemented system for three dimensional reconstruction and transformation for automatic measurement and three dimensional visualization of any objects using a photograph/image, comprising:
a processor unit;
a computer readable medium storing instructions executable by the processor unit to perform the steps of:
capturing an image on a device;
viewing a photograph of the image on the device; and
performing a transforming operation on the image using at least one reconstruction or interpolation algorithm.

2. The system as claimed in claim 1, further comprising photogrammetric real-world measurement as well as enabling three dimensional visualization capabilities.

3. The system as claimed in claim 1, wherein the measurements show a distance between two selected feature points displayed as a line distance between the two feature points.

4. The system as claimed in claim 1, further comprising image displaying the measurements as an electronic fluorescent display superimposed over the captured image.

5. The system as claimed in claim 1, wherein the three dimensional visualization is achieved using perspective correction and three dimensional rendering of the photograph.
